(19) United States
(12) Patent Application Publication
(10) Pub. No.: US 2022/0351230 A1
(43) Pub. Date: Nov. 3, 2022

(54) GAME RELATING TO GREENHOUSE GASES AND CLIMATE CHANGE

(71) Applicant: Gilbert Eisner, Las Vegas, NV (US)

(72) Inventor: Gilbert Eisner, Las Vegas, NV (US)

(21) Appl. No.: 17/730,014

(22) Filed: Apr. 26, 2022

Related U.S. Application Data
(60) Provisional application No. 63/182,324, filed on Apr. 30, 2021.

(51) Int. Cl. G06Q 30/02; G06Q 50/26

(52) U.S. Cl. CPC G06Q 30/0209; G06Q 50/26

(57) ABSTRACT

A game that addresses the causes of global warming and climate change is disclosed. Participants of the game can purchase vouchers that contain information of a country, location, or industry and its greenhouse gases production source and quantities. During the game period, the purchased vouchers may be sold, transferred, or exchanged with another party or participant. The participants may educate themselves using the educational materials on the vouchers. At the end of the game period, the winner vouchers are determined and the participants who own the winner vouchers are rewarded. The winner vouchers are the vouchers that contain information of a country, location, or industry with reduced greenhouse gases quantities.

### FIELD OF THE INVENTION

The present invention relates generally to a method of a game. More specifically, the present invention is a game that addresses the cause of climate change and global warming issues. Further, the present invention is designed to build consciousness, be informative, educational, and financially rewarding to users.

### BACKGROUND OF THE INVENTION

Climate change and global warming refer to the large-scale shifts in weather patterns, resulting from and driven by human-induced emissions of greenhouse gases. Modern industrialization and societal advances have increased substantially the normal amount of greenhouse gas emissions released into the atmosphere and caused the earth's warming effect commonly referred to as green housing. The resultant effect of green housing is significant changes in global climate. Greenhouse gases are a category of gases which are produced by various global activities which when they enter the atmosphere create an earth warming effect known as green housing. Over the millenniums these gases have been generated by natural events and have established stable climate conditions which the earth has enjoyed for millions of years. Since the industrial revolution, the increase in the quantity of greenhouse gases generated has changed that balance and is the principal cause of climate change.

The most environmentally damaging of these gases are carbon dioxide and methane. They are created every year in quantities of billions of tonnes. Generally, greenhouse gas sources are categorized into two classes, natural and manmade. Their sources can be identified by type, country, industry, or specific source. The actual amount of greenhouse gases generated and their sources are identified, categorized, and calculated on a global basis by various organizations such as the United Nations and EPA. To mitigate climate change, there are global efforts to reduce the generation and/or release of these man-made greenhouse gases.

An objective of the present invention is to provide a method of a game that builds consciousness of the aforementioned global warming and related climate issues. The game is not only informative and educational but has a financial incentive and reward to the winning participants. A participant can purchase a voucher that contains information of a country, location, and/or industry which is classified as a greenhouse gases production source. After a determined amount of time, winning vouchers are randomly determined based on the total reduction quantity of greenhouse gases in tons achieved during the game period. Voucher features and benefits are further discussed in the following sections.

### BRIEF DESCRIPTION OF THE DRAWINGS

FIG. 1 is a flowchart illustrating the overall game period for the present invention.

FIG. 2 is a flowchart illustrating the process of the voucher sale period of the present invention.

FIG. 3 is a flowchart illustrating the process of the in-game play period of the present invention.

FIG. 4 is a flowchart illustrating the process of the game end period of the present invention.

FIG. 5 is an illustration of an exemplary online platform of the present invention.

FIG. 6 is an illustration of exemplary computing devices and cloud services of the present invention.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods for bringing attention to global warming and climate change issues, embodiments of the present disclosure are not limited to use only in this context.

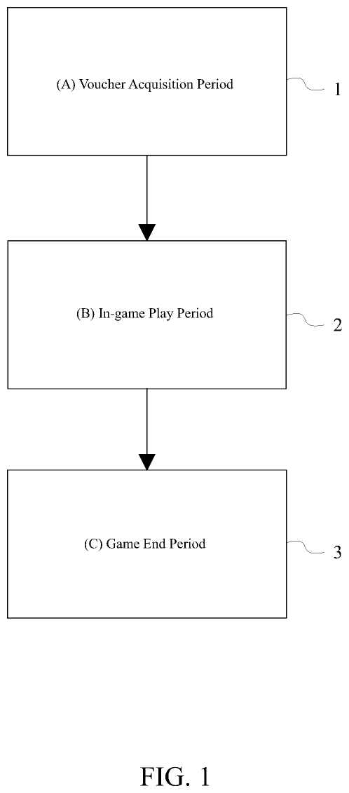

The present invention discloses the methods of a game configured for bringing attention to, educating, and rewarding participants about an important global challenge of our contemporary society. The central core of the game is related to the reduction of greenhouse gases over a defined period of time. The game is conceptualized to be open to the public, requiring no qualifications or specialized skills by a participant. Participation will be open to any entity or person regardless of structure, location, gender, age, ethnicity, or race. With reference to FIG. 1, in the preferred embodiment, the present invention comprises game periods which are defined as the voucher acquisition period 1, in-game play period 2, and game end period 3.

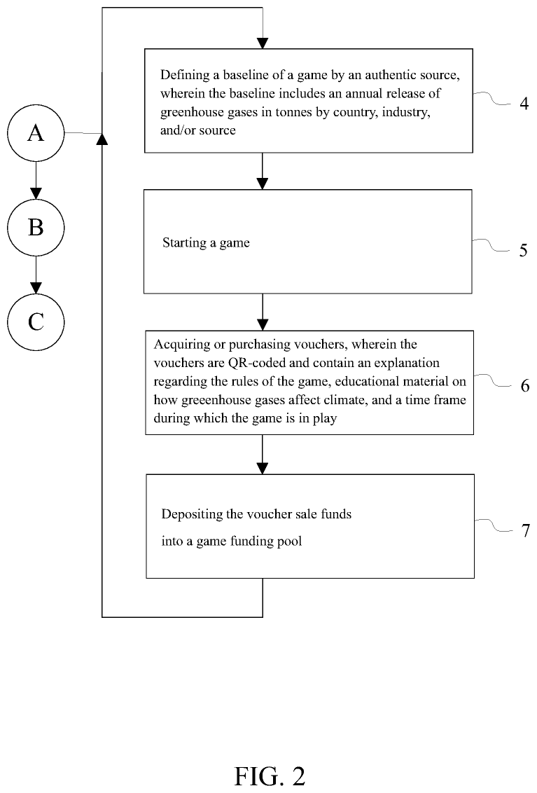

With reference to FIG. 2, during the voucher acquisition period 1, the game baseline is established by an authentic source such as a united nations (UN) which defines the annual release of greenhouse gases in tonnes by country, industry, and/or source 4. The game baseline includes an annual release of greenhouse gases in tonnes by country, industry, and/or source. The game baseline is stored in databases 114. Once the game baseline is established, the game starts 5. Participants may select a country, industry, or source for their voucher acquisition. The voucher acquisition can be done from the participant's electronic devices 110 or a mobile device 106. Each voucher contains information of a voucher owner information such as a name or an identification number, a game duration, a greenhouse gas production value in tonnes, and a set voucher price. The information that each voucher contains are uniquely identified to the participant by computer coding. The voucher is computer encoded with the relative information mentioned above and data associated with the participant and will be utilized as the participant's play piece during the course of the game. Participants may also acquire a random voucher which represents a specific greenhouse gas attribution to one of the sources of greenhouse gas. The random voucher randomly chooses the county, industry, or source of greenhouse gas for the participant. Accompanying each voucher is an explanation regarding the rules of the game and educational material on how greenhouse gases affect climate 6. The voucher may cover a specifically identified gas, a source, and the time frame during which the game is in play 6. The vouchers may be quick response (QR)-coded in order to identify details of the game baseline and selected country, industry, or source of the voucher 6. Computer and information technology associated with such designs as QR coding currently provides comprehensive opportunities of coding techniques that can provide a wealth of game-associated database information. As employed in the game, the QR type coding will provide information and data about the participant as to their identifier, email address, location, the game reference, the participant's defined set of selected greenhouse gas game information, and an associated winners' pool identifier. The QR coded information and data can be displayed on participant's electronic devices 110 or mobile device 106. In the preferred embodiment, voucher sale funds are deposited into game funding pools, operational, and administrative costs 7.

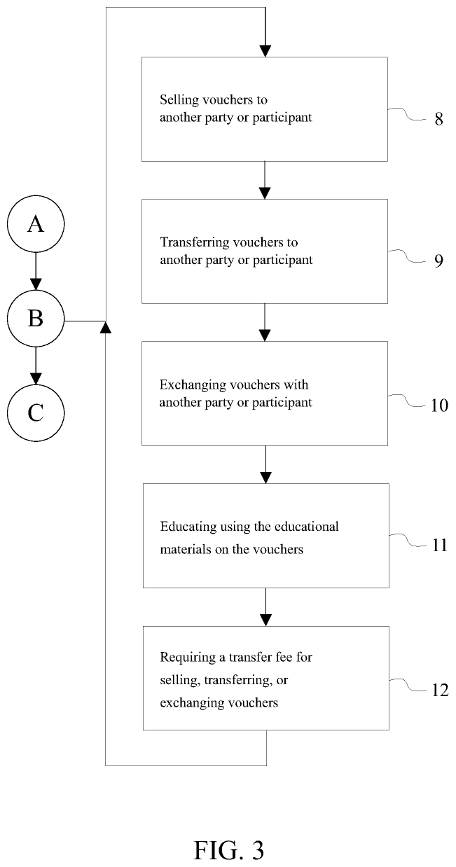

With reference to FIG. 3, during the in-game play period 2, the participant's vouchers may be sold 8, transferred 9, or exchanged 10 with another party or participant. The participants can educate themselves using the educational materials on the vouchers 11. Selling, transferring, or exchanging vouchers requires a transfer fee 12.

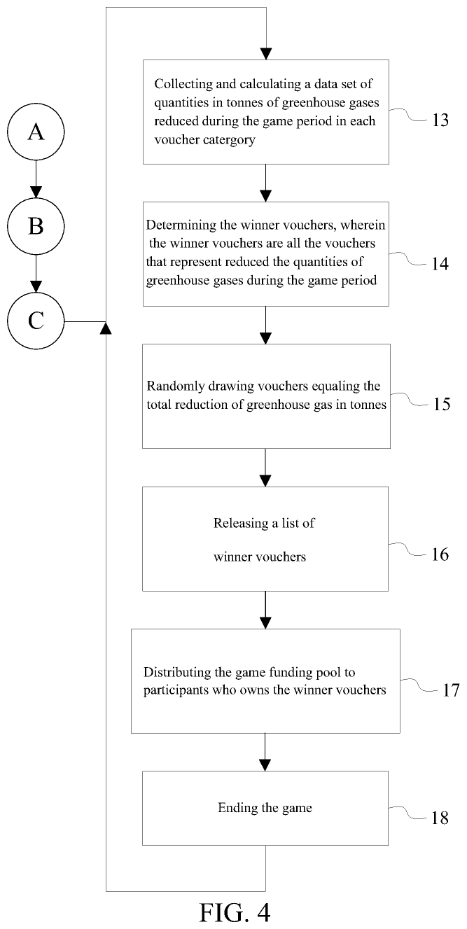

With reference to FIG. 4, during the game end period 3, a data set of the quantities in tonnes of greenhouse gases reduced during the game period are calculated in each voucher category 13. Only those vouchers with greenhouse gases reductions during the game period are considered in play. The vouchers with no reduction of greenhouse gas are out of gameplay. All the vouchers that represent reduced quantities of greenhouse gases are considered in a winning category 14 and from which the vouchers equaling the total reduction of greenhouse gas in tonnes will be randomly drawn again to be considered in the winning category 15. The randomly drawn vouchers will be considered in the winning category. The lists of winning vouchers are released 16, and the game funding pools are distributed 17. The game funding pools can be distributed as checks or sent through internet banking. That game has ended, and another new game can be started and go through the same game periods 18. Games can be created and run concurrently with other game sets.

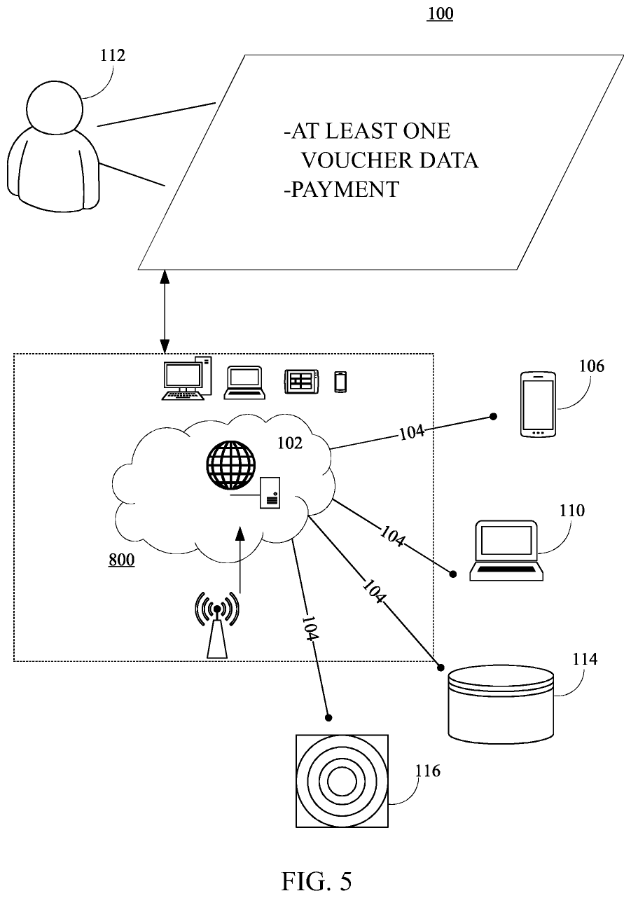

Referring now to figures, FIG. 5 is an illustration of an online platform 100 consistent with various embodiments of the present disclosure. By way of non-limiting example, the online platform 100 for a game configured for bringing attention to, educating, and rewarding participants about an important global challenge of our contemporary society may be hosted on a centralized server 102, such as, for example, a cloud computing service. The centralized server 102 may communicate with other network entities, such as, for example, the mobile device 106 (such as a smartphone, a laptop, a tablet computer, etc.), other electronic devices 110 (such as desktop computers, server computers, etc.), databases 114, and sensors 116, over a communication network 104, such as, but not limited to, the Internet. Further, users of the online platform 100 may include relevant parties such as, but not limited to, participants and administrators. Accordingly, in some instances, electronic devices operated by the one or more relevant parties may be in communication with the online platform 100. A user 112, such as the one or more relevant parties, may access the online platform 100 through a web-based software application or browser. The web-based software application may be embodied as, for example, but not be limited to, a website, a web application, a desktop application, and a mobile application compatible with a computing device 2300.

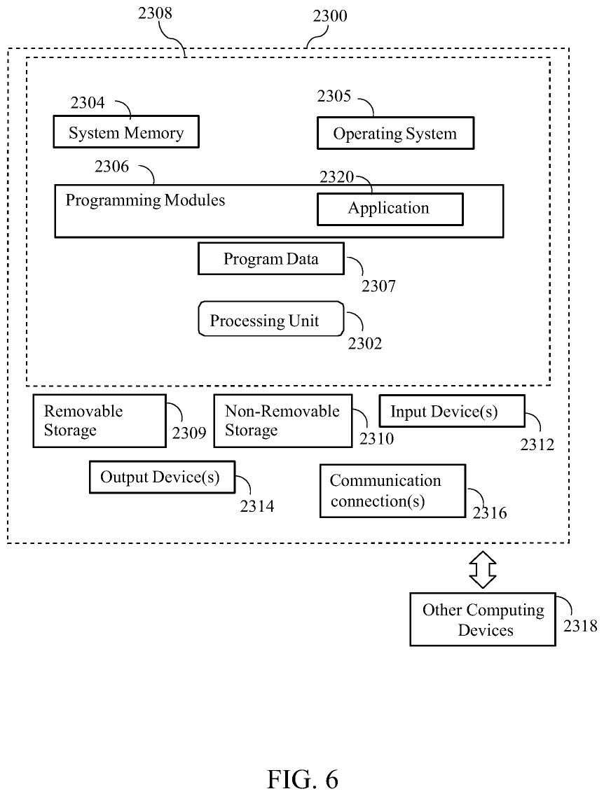

With reference to FIG. 6, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g. random-access memory (RAM)), non-volatile (e.g. read-only memory (ROM)), flash memory, or any combination. System memory 2304 may include operating system 2305, one or more programming modules 2306, and may include a program data 2307. Operating system 2305, for example, may be suitable for controlling computing device 2300's operation. In one embodiment, programming modules 2306 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 6 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 6 by a removable storage 2309 and a non-removable storage 2310. Computer storage media may include volatile and nonvolatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2300. Any such computer storage media may be part of device 2300. Computing device 2300 may also have input device(s) 2312 such as a keyboard, a mouse, a pen, a sound input device, a touch input device, a location sensor, a camera, a biometric sensor, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2304, including operating system 2305. While executing on processing unit 2302, programming modules 2306 (e.g., application 2320 such as a media player) may perform processes including, for example, one or more stages of methods, algorithms, systems, applications, servers, databases as described above. The aforementioned process is an example, and processing unit 2302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method for a game that addresses the causes of global warming and climate change, the method comprises steps of:
defining a baseline of a game by an authentic source, wherein the baseline includes an annual release of greenhouse gases in tonnes by country, industry, and/or source;
acquiring a voucher, wherein the voucher is QR-coded and contain an explanation regarding the rules of the game, educational material on how greenhouse gases affect climate, and a time frame during which the game is in play;
depositing vouchers sale funds into a game funding pool;
initiating the vouchers selling requests;
educating using the educational materials on the vouchers;
requiring a transfer fee for selling, transferring, or exchanging the voucher;
collecting and calculating a data set of quantities in tonnes of greenhouse gases reduced during the game period in each voucher;
determining winner vouchers, wherein the winner vouchers are all the vouchers that represent reduced quantities of greenhouse gases;
randomly drawing vouchers from the winning vouchers that equaling the total reduction of greenhouse gas in tonnes;
releasing a list of winner vouchers; and
distributing the game funding pool to participants who own the winner vouchers.

2. The method for a game that addresses the causes of global warming and climate change, the method as claimed in claim 1 comprises steps of:
storing the baseline of the game in databases;
acquiring the voucher from electronic devices or a mobile device; and
displaying the vouchers on electronic devices or the mobile device.

3. The method for a game that addresses the causes of global warming and climate change, the method as claimed in claim 1 comprises steps of: initiating the vouchers transferring requests.

4. The method for a game that addresses the causes of global warming and climate change, the method as claimed in claim 1 comprises steps of: initiating the vouchers exchanging requests.

5. The method for a game that addresses the causes of global warming and climate change, the method as claimed in claim 1 comprises steps of:
initiating the vouchers transferring requests and initiating the vouchers exchanging requests.

6. A method for a game that addresses the causes of global warming and climate change, the method comprises steps of:
defining a baseline of a game by an authentic source, wherein the baseline includes an annual release of greenhouse gases in tonnes by country, industry, and/or source;
acquiring a voucher, wherein the voucher is QR-coded and contain an explanation regarding the rules of the game, educational material on how greenhouse gases affect climate, and a time frame during which the game is in play;
depositing vouchers sale funds into a game funding pool;
initiating the vouchers selling requests;
initiating the vouchers transferring requests;
educating using the educational materials on the vouchers;
requiring a transfer fee for selling, transferring, or exchanging the voucher;
collecting and calculating a data set of quantities in tonnes of greenhouse gases reduced during the game period in each voucher;
determining winner vouchers, wherein the winner vouchers are all the vouchers that represent reduced quantities of greenhouse gases;
randomly drawing vouchers from the winning vouchers that equaling the total reduction of greenhouse gas in tonnes;
releasing a list of winner vouchers; and
distributing the game funding pool to participants who own the winner vouchers.

7. The method for a game that addresses the causes of global warming and climate change, the method as claimed in claim 6 comprises steps of:
storing the baseline of the game in databases;
acquiring the voucher from electronic devices or a mobile device; and
displaying the vouchers on electronic devices or the mobile device.

8. A method for a game that addresses the causes of global warming and climate change, the method comprises steps of:
defining a baseline of a game by an authentic source, wherein the baseline includes an annual release of greenhouse gases in tonnes by country, industry, and/or source;
acquiring a voucher, wherein the voucher is QR-coded and contain an explanation regarding the rules of the game, educational material on how greenhouse gases affect climate, and a time frame during which the game is in play;
depositing vouchers sale funds into a game funding pool;
initiating the vouchers selling requests;
initiating the vouchers transferring requests;
initiating the vouchers exchanging requests;
educating using the educational materials on the vouchers;
requiring a transfer fee for selling, transferring, or exchanging the voucher;
collecting and calculating a data set of quantities in tonnes of greenhouse gases reduced during the game period in each voucher;
determining winner vouchers, wherein the winner vouchers are all the vouchers that represent reduced quantities of greenhouse gases;
randomly drawing vouchers from the winning vouchers that equaling the total reduction of greenhouse gas in tonnes;
releasing a list of winner vouchers; and
distributing the game funding pool to participants who own the winner vouchers.

9. The method for a game that addresses the causes of global warming and climate change, the method as claimed in claim 8 comprises steps of:
storing the baseline of the game in databases;
acquiring the voucher from electronic devices or a mobile device; and
displaying the vouchers on electronic devices or the mobile device.
